(19) United States
(12) Patent Application Publication
(10) Pub. No.: US 2023/0108069 A1
(43) Pub. Date: Apr. 6, 2023

(54) Non-primary hydroxyl group based foams

(71) Applicant: BASF SE, Ludwigshafen am Rhein (DE)

(72) Inventors: Frank Thielbeer, Lemfoerde (DE); Lisa Marie Schmidt, Lemfoerde (DE); Theresa Huelsmann, Lemfoerde (DE); Elmar Poeselt, Lemfoerde (DE); Peter Gutmann, Ludwigshafen am Rhein (DE); Uwe Keppeler, Ludwigshafen am Rhein (DE); Amir Doroodian, Lemfoerde (DE); Barbara Revaliente Bolivar, Lemfoerde (DE); Michael Freese, Lemfoerde (DE); Frank Schaefer, Lemfoerde (DE)

(73) Assignee: BASF SE, Ludwigshafen am Rhein (DE)

(21) Appl. No.: 17/905,007

(22) PCT Filed: Feb. 26, 2021
(86) PCT No.: PCT/EP2021/054829

§ 371 Date: Aug. 25, 2022

(30) Foreign Application Priority Data
Feb. 28, 2020 (EP) 20160027.7

(51) Int. Cl. C08J 9/232; C08J 9/12; C08J 9/16; C08G 18/10; C08G 18/24; C08G 18/66; C08G 18/32; C08G 18/76; C08G 18/48; C08L 75/08

(52) U.S. Cl. CPC C08J 9/232; C08J 9/122; C08J 9/16; C08G 18/10; C08G 18/24; C08G 18/6674; C08G 18/3206; C08G 18/7671; C08G 18/4825; C08L 75/08; C08J 2203/06; C08J 2201/03; C08J 2375/08; C08G 2101/00

(57) ABSTRACT

Foamed pellets contain a thermoplastic polyurethane obtainable or obtained by a process. The process involves reacting a polyol composition (PZ-1) containing at least one hydroxy functionalized polyol (P1) with a maximum of 20% of primary hydroxyl groups with a polyisocyanate (I1), to obtain a polyol composition (PZ-2) containing a prepolymer (PP-1). The process then involves reacting the polyol composition (PZ-2) containing the prepolymer (PP-1) with a composition (C2) containing a chain extender (CE) with a molecular weight<500 g/mol. Foamed pellets are obtained or obtainable by the process. The foamed pellets can be used for the production of a molded body.

The present invention is directed to foamed pellets comprising a thermoplastic polyurethane obtainable or obtained by a process comprising reacting a polyol composition (PZ-1) comprising at least one hydroxy functionalized polyol (P1) with maximal 20% of primary hydroxyl groups with a polyisocyanate (I1) to obtain a polyol composition (PZ-2) containing a prepolymer (PP-1), and reacting polyol composition (PZ-2) containing the prepolymer (PP-1) with a composition (C2) comprising a chain extender (CE) with a molecular weight<500 g/mol. The present invention further is directed to foamed pellets obtained or obtainable by the process according to the present invention process and the use of foamed pellets according to the invention for the production of a molded body.

Foamed pellets, which are also referred to as bead foams (or particle foams), and also molded bodies produced from them, based on thermoplastic polyurethane or other elastomers, are known (e.g. WO 94/20568 Al, WO 2007/082838 A1, WO2017030835 Al, WO 2013/153190 A1, WO2010/010010 A1) and have manifold possible uses.

Within the meaning of the present invention, “foamed pellets” or else a “bead foam” or “particle foam” refers to a foam in bead form, wherein the average diameter of the beads is from 0.2 to 20 mm, preferably 0.5 to 15 mm and especially from 1 to 12 mm. In the case of non-spherical, e.g. elongate or cylindrical, beads, diameter means the longest dimension.

In principle, there is a need for foamed pellets or bead foams which are readily available and have sufficient mechanical properties and processability to give the corresponding molded bodies at minimal temperatures while maintaining advantageous mechanical properties.

In principle, there is a need to use polymers which can be prepared from cost efficient polyols. Polyols having secondary hydroxyl groups would be suitable for the preparation of polyurethanes but due to the lower reactivity of the secondary hydroxyl groups, product with low molecular weight and insufficient properties for the preparation of foamed particles are obtained. Thus, polyurethanes for the preparation of foamed particles starting from polyols with secondary hydroxyl groups cannot be prepared using established procedures for the polyurethane preparation.

Different approaches have been reported in the state of the art to prepare polyurethanes from polyols having secondary hydroxyl groups. The polymers obtained often have insufficient mechanical properties for the preparation of foamed particles.

The use of polypropylene glycol as a starting material in the production of thermoplastic polyurethanes is disclosed, for example, in WO 02/064656A2. Thermoplastic polyurethanes are manufactured in a one-shot process using polyols with a high proportion of secondary hydroxyl groups. WO 93/24549 Al and US 2006/0258831 A1 also disclose one-shot processes for producing thermoplastic polyurethanes using polyols with secondary OH groups. The preparation of foamed particles is not disclosed.

EP 1746117 A1 discloses a process for the preparation of prepolymers containing isocyanate groups with a low content of monomeric isocyanates by reacting diisocyanates with at least one compound having more than two hydrogen atoms reactive with isocyanate groups and optionally subsequently removing the unreacted monomeric diisocyanates. A one-shot process using prepolymers is disclosed. The preparation of foamed particles is not disclosed.

Within the context of the present invention, “advantageous mechanical properties” are to be interpreted with respect to the intended applications. The most prominent application for the subject matter of the present invention is the application in the shoe sector, where the foamed pellets can be used for molded bodies.

Because of the low cost and readily availability, polyols with secondary hydroxyl groups such as polyether polyols based on propylene oxide or polyester polyols are an interesting raw material for the production of thermoplastic polyurethanes. In particular polypropylene glycols are interesting starting materials for polyurethanes. Due to the lower reactivity of polyols having secondary hydroxyl groups, they are less frequently used in the production of thermoplastic polyurethanes. Due to the lower reactivity of the secondary hydroxyl groups it is difficult to obtain high molecular weight polymers. To avoid these problems, additives such as cross linkers are used for the TPU formation which in turn can cause problems in the process to prepare foamed particles from the respective TPU.

Accordingly, it was an object of the present invention to provide foamed pellets comprising thermoplastic polyurethanes based on polyols with maximal 20% of primary hydroxyl groups which have good mechanical properties. Another object of the present invention was to provide a process for the production of the corresponding foamed pellets.

According to the invention, this object is achieved by foamed pellets comprising a thermoplastic polyurethane obtainable or obtained by a process comprising steps (i) and (ii):
(i) reacting a polyol composition (PZ-1) comprising at least one hydroxy functionalized polyol (P1) with maximal 20% of primary hydroxyl groups with a polyisocyanate (I1) to obtain a polyol composition (PZ-2) containing a prepolymer (PP-1),
(ii) reacting polyol composition (PZ-2) containing the prepolymer (PP-1) with a composition (C2) comprising a chain extender (CE) with a molecular weight<500 g/mol.

It has surprisingly been found that the foamed pellets according to the invention, which can be produced using a non-primary hydroxyl functionalized polyol with a high proportion of secondary terminal OH groups, for example polypropylene glycol, have sufficient mechanical properties.

Surprisingly, the use of additives such as cross linkers in the foaming process as such is not problematic.

According to the present invention, it has been found that it can be advantageous to carry out the process for preparing the thermoplastic polyurethane continuously, for example continuous production of a pre-polymer which is then reacted further, with a conversion of up to 100%, that is to say for example 90% of the preparation of the prepolymer is sufficient to achieve the de-sired mechanical properties of the thermoplastic polyurethanes produced according to the invention. This makes it possible according to the invention to avoid an uneconomical degree of conversion of the prepolymer of 100% for an in-situ TPU process.

Further on, the eTPU can be obtained directly by reacting the prepolymer with further TPU components and production of eTPU in a reactive extruder or tandem extrusion.

The foamed pellets according to the present invention comprise thermoplastic polyurethanes which are obtainable or are obtained by a process comprising at least steps (i) and (ii). The process makes it possible to use polyols with a maximum of 20% of primary hydroxyl groups for the production of the thermoplastic polyurethanes and to carry out the process in a targeted manner so that foamed pellets with good mechanical properties are obtained.

It has surprisingly been found that thermoplastic polyurethanes of this type can be readily processed to give foamed pellets, which in turn can be readily processed to give molded bodies which have sufficient elasticity and mechanical properties for many applications

In step (i), the polyol composition (PZ-1) comprising at least one hydroxy functionalized polyol (P1) with maximal 20% of primary hydroxyl groups is first reacted with a polyisocyanate (I1) to obtain a polyol composition (PZ-2) containing a prepolymer (PP-1). The polyol composition (PZ-1) used comprises polyol (P1), the proportion of the secondary terminal OH groups in the total number of terminal OH groups of the polyol preferably being in the range from 80 to 100%.

The polyol composition (PZ-2) containing the prepolymer (PP-1) obtained in the reaction is then reacted in step (ii) with a composition (C2) comprising a chain extender (CE) with a molecular weight<500 g/mol.

Unless otherwise stated, the average molecular weight Mn of the polyols used is determined via the OH number according to DIN 53240-1-2013-06 in the context of the present invention.

Polyol (P1) is a hydroxy functionalized polyol with maximal 20% of primary hydroxyl groups. Preferably, the proportion of the secondary terminal OH groups in the total number of terminal OH groups of the polyol preferably being in the range from 80 to 100%, more preferable the polyol (P1) contains more than 94% non-primary hydroxyl groups, in particular more than 98% non-primary hydroxyl groups, preferably more than 99% non-primary hydroxyl groups.

According to a further embodiment, the present invention is also directed to foamed pellets as disclosed above, wherein the polyol (P1) contains more than 94% non-primary hydroxyl groups.

Suitable polyols containing non-primary hydroxyl groups are in principle known. Suitable are for example polyether polyols, such as polymers having propylene oxide blocks, propylene oxide capped polymers, polyethylene/polypropylene oxide copolymers, butylene oxide polymers, butylene oxide capped polymers. Suitable polyols may also be polyester polyols such as for example poly(2-ethyl-1,3-hexamethylene adipate) glycol.

Suitable polyols are for example selected from polypropylene glycols. Mixtures containing polypropylene glycols can also be used in the context of the present invention.

According to a further embodiment, the present invention is also directed to foamed pellets as disclosed above, wherein the polyol (P1) is polypropylene glycol.

Polypropylene glycols suitable for the production of the thermoplastic polyurethanes according to the invention are known in principle. For example, according to the invention, polypropylene glycols are suitable which have a number average molecular weight Mn in the range from 500 g/mol to 2500 g/mol, in particular a number average molecular weight Mn in the range from 850 g/mol to 2200 g/mol, more preferably a number average molecular weight Mn in the range from 950 g/mol to 2100 g/mol, particularly preferably a number average molecular weight Mn in the range from 1000 g/mol to 2000 g/mol, more preferably a number average molecular weight Mn in the range from 1200 g/mol to 1750 g/mol, for example a molecular weight Mn of 1400 g/mol.

It has been shown that in particular polypropylene glycols with higher molecular weights, for example an average molecular weight Mn of greater than 2000 g/mol, lead to less good mechanical properties of the thermoplastic polyurethane obtained. The use of mixtures of different polypropylene glycols also leads to poor mechanical properties.

The polyols used preferably have a polydispersity Pd of less than 2, more preferably in the range from 1.0 to 1.4.

According to a further embodiment, the present invention is also directed to foamed pellets as disclosed above, wherein the number average molar mass (Mₙ) of the polyol (P1) is in the range of from 500 to 2500 g/mol.

Within the context of the present invention, the composition of the polyol composition (PZ-1) and (PZ-2) respectively can vary within wide ranges. The polyol composition can also comprise mixtures of various polyols.

Suitable further polyols are for example polytetramethylene oxides, polytrimethylene oxids, polyethylene glycols, or polyesterpolyols and polycarbonate diols.

According to the invention, the polyol composition may also comprise a solvent. Suitable solvents are known per se to those skilled in the art.

According to the present invention, a large part of the secondary terminal OH groups of the polyol (P1) is reacted, for example at least 50% of the secondary terminal OH groups of the polyol (P1), more preferably at least 70% of the secondary terminal OH groups of the polyol (P1), in particular at least 80% of the secondary, terminal OH groups of the polyol (P1), in particular at least 90% or at least 95%, in particular at least 99% of the secondary, terminal OH groups of the polyol (P1).

According to the invention, the reaction in step (i) is carried out in such a way that the secondary terminal OH groups of the polyol (P1) are reacted.

For this purpose, for example, the temperature and reaction time but also the mixing quality are optimized. For example, the reaction can be carried out under adiabatic conditions for a period of 30 minutes. The reaction time in the context of the present invention is further preferably sufficient for the completion of the prepolymer formation. The reaction is preferably carried out at a temperature of T less than 200° C., preferably less than 180° C., in particular less than 150° C.

In the reaction in step (i), the polyol composition (PZ-1) is reacted with a polyisocyanate (I1). The polyol composition (PZ-1) can contain other components in addition to the polyol (P1). In the context of the present invention, the proportion of polyol (P1) in the polyol composition (PZ-1) is greater than 75%, more preferably greater than 90%, in particular greater than 95%. For example, the proportion of polyol (P1) in the polyol composition (PZ-1) is in the range from 95% to 99%, in each case based on the total polyol composition (PZ-1).

Suitable polyisocyanates are known per se to the person skilled in the art. According to the invention, at least one polyisocyanate (I1) is used. In the context of the present invention, the term polyisocyanate also encompasses diisocyanates. According to the invention, mixtures of two or more polyisocyanates can also be used as an isocyanate composition (IC) comprising the polyisocyanate (I1).

Suitable isocyanates within the context of the present invention are in particular diisocyanates, in particular aliphatic or aromatic diisocyanates, more preferably aromatic diisocyanates. In addition, within the context of the present invention, pre-reacted products may be used as isocyanate components, in which some of the OH components are reacted with an isocyanate in a preceding reaction step. The products obtained are reacted with the remaining OH components in a subsequent step, the actual polymer reaction, thus forming the thermoplastic polyurethane.

Aliphatic diisocyanates used are customary aliphatic and/or cycloaliphatic diisocyanates, for example tri-, tetra-, penta-, hexa-, hepta- and/or octamethylene diisocyanate, 2-methylpentamethylene 1,5-diisocyanate, 2-ethyltetramethylene 1,4-diisocyanate, butylene 1,4-diisocyanate, trimethylhexamethylene 1,6-diisocyanate, 1-isocyanato-3,3,5-trimethyl isocyanatomethylcyclohexane (isophorone diisocyanate, IPDI), 1,4- and/or 1,3-bis(isocyanatomethyl)cyclohexane (HXDI), cyclohexane 1,4-diisocyanate, 1-methyl cyclohexane 2,4-diisocyanate and/or 1-methylcyclohexane 2,6-diisocyanate, methylene dicyclohexyl 4,4′-, 2,4′- and/or 2,2′-diisocyanate (H12MDI).

Suitable aromatic diisocyanates are in particular naphthylene 1,5-diisocyanate (NDI), tolylene 2,4- and/or 2,6-diisocyanate (TDI), 3,3′-dimethyl-4,4′-diisocyanatobiphenyl (TODD, p-phenylene diisocyanate (PDI), diphenylethane 4,4′-diisocyanate (EDI), methylene diphenyl diisocyanate (MDI), where the term MDI is understood to mean diphenylmethane 2,2′, 2,4′- and/or 4,4′-diisocyanate, dimethyldiphenyl 3,3′-diisocyanate, diphenylethane 1,2-diisocyanate and/or phenylene diisocyanate

Mixtures can in principle also be used. Examples of mixtures are mixtures comprising at least one further methylene diphenyl diisocyanate besides methylene diphenyl 4,4′-diisocyanate. The term “methylene diphenyl diisocyanate” here means diphenylmethane 2,2′-, 2,4′- and/or 4,4′-diisocyanate or a mixture of two or three isomers. It is therefore possible to use as further isocyanate, for example, diphenylmethane 2,2′- or 2,4′-diisocyanate or a mixture of two or three isomers. In this embodiment, the polyisocyanate composition can also comprise other abovementioned polyisocyanates.

If further isocyanates are used, these are present in the isocyanate composition (IC) preferably at an amount in the range from 0.1% to 50% by weight, more preferably in the range from 0.1% to 20% by weight, further preferably in the range from 0.1% to 10% by weight and particularly preferably at an amount in the range from 0.5% to 5% by weight.

Preferred examples of higher-functionality isocyanates are triisocyanates, for example triphenylmethane 4,4′,4″-triisocyanate, and also the cyanurates of the aforementioned diisocyanates, and the oligomers obtainable by partial reaction of diisocyanates with water, for example the biurets of the aforementioned diisocyanates, and also oligomers obtainable by controlled reaction of semiblocked diisocyanates with polyols having an average of more than two and preferably three or more hydroxyl groups.

Organic isocyanates that can be used are aliphatic, cycloaliphatic, araliphatic and/or aromatic isocyanates.

Crosslinkers can additionally also be used, for example the previously mentioned higher-functionality polyisocyanates or polyols, or else other higher-functionality molecules having a plurality of isocyanate-reactive functional groups. It is likewise possible within the context of the present invention to achieve crosslinking of the products through an excess of the isocyanate groups used in proportion to the hydroxyl groups. Examples of higher-functionality isocyanates are triisocyanates, for example triphenylmethane 4,4′,4″-triisocyanate and isocyanurates, and also the cyanurates of the aforementioned diisocyanates, and the oligomers obtainable by partial reaction of diisocyanates with water, for example the biurets of the aforementioned diisocyanates, and also oligomers obtainable by controlled reaction of semiblocked diisocyanates with polyols having an average of more than two and preferably three or more hydroxyl groups.

Here, within the context of the present invention, the amount of crosslinker, that is to say of higher-functionality isocyanates and higher-functionality polyols or higher-functionality chain extenders, is no greater than 3% by weight, preferably less than 1% by weight, further preferably less than 0.5% by weight, based on the total mixture of the components.

The polyisocyanate composition may also comprise one or more solvents. Suitable solvents are known to those skilled in the art. Suitable examples are nonreactive solvents such as ethyl acetate, methyl ethyl ketone and hydrocarbons.

The reaction in step (i) can be carried out in any suitable device known to the person skilled in the art, as long as it is ensured that the reaction conditions can be set so that the secondary terminal OH groups of the polyol (P1) are reacted.

According to the invention, the reaction in step (i) takes place, for example, at a temperature in the range from 60 to 300° C. for a time in the range up to 5 hours, with the polyol composition (PZ-2) being obtained. According to the invention, the reaction in step (i) is preferably carried out for a time in the range from 1 minute to 180 minutes, more preferably in the range from 1 minute to 30 minutes, particularly preferably in the range from 1 minute to 20 minutes.

According to the invention, the temperature is preferably in the range from 60 to 300° C., preferably in the range from 80 to 220° C., and particularly preferably in the range from 80 to 180° C.

The reaction in step (i) is preferably carried out continuously.

According to the invention, the reaction can take place in a suitable apparatus, suitable processes being known per se to the person skilled in the art. For example, static mixers, reaction extruders or stirred tanks are suitable for the reaction in step (i). Accordingly, in another embodiment, the present invention also relates to a thermoplastic polyurethane as described above, the reaction in step (i) taking place in a static mixer, reaction extruder or stirred tank (Continuous Stirred Tank Reactors, CSTR) or combinations thereof.

For example, a stirrer in a container or a mixing head or a high-speed tube mixer, a nozzle or a static mixer can be used. The reaction can also be carried out in an extruder or part of a multi-screw extruder.

The components are mixed, for example, with a mixing unit, in particular in a mixing unit working with high shear energy. Examples include a mixing head, a static mixer, a nozzle or a multi-screw extruder.

The temperatures of the extruder housings are advantageously chosen so that the reaction components are brought to full conversion and the possible incorporation of further auxiliaries or the further components can be carried out with the greatest possible protection of the product.

For example, the reaction in step (i) can take place in a static mixer or reactive mixer/extruder and the reaction in step (ii) can be carried out in an extruder or belt process.

For example, the reaction according to step (i), the reaction according to step (ii) or the reaction according to step (i) and step (ii) can take place in an extruder.

According to a preferred embodiment of the present invention, the conversion according to step (i) takes place in a static mixer and the conversion according to step (ii) takes place in a belt process.

In the reaction according to step (i), the polyol composition (PZ-2) containing the prepolymer (PP-1) is obtained according to the invention. According to the invention, the polyol composition (PZ-2) is a mixture. According to the invention, the mixture can contain unreacted starting materials, for example unreacted polyisocyanate (I1) or unreacted polyol composition (PZ-1). According to the invention, the reaction product is in the form of a mixture, it being possible for the individual molecules to differ, for example, in the distribution and the length of the blocks.

According to the invention, the polyol composition (PZ-2) is reacted further according to step (ii). The polyol composition (PZ-2) can be reacted directly or further polyols can be added.

Other polyols are known in principle to the person skilled in the art and are described, for example, in “Plastics Handbook, Volume 7, Polyurethanes”, Carl Hanser Verlag, 3rd Edition 1993, Chapter 3.1.

According to step (ii), polyol composition (PZ-2) containing the prepolymer (PP-1) is reacted with a composition (C2) comprising a chain extender (CE) with a molecular weight<500 g/mol.

Suitable chain extenders are known per se to those skilled in the art. By way of example, chain extenders are compounds having two groups which are reactive towards isocyanate groups.

Suitable chain extenders are for example diamines or diols. Diols are more preferred according to the invention. Within the scope of the present invention, mixtures of two or more chain extenders may also be used.

Suitable diols are known in principle to those skilled in the art. According to the invention, the diol has a molecular weight of <500 g/mol. According to the invention, aliphatic, araliphatic, aromatic and/or cycloaliphatic diols having a molecular weight of 50 g/mol to 220 g/mol can be used here as chain extenders, for example. Preference is given to alkanediols having 2 to 10 carbon atoms in the alkylene radical, especially di-, tri-, tetra-, penta-, hexa-, hepta-, octa-, nona- and/or decaalkylene glycols. For the present invention, particular preference is given to 1,2-ethylene glycol, propane-1,3-diol, butane-1,4-diol, hexane-1,6-diol.

Suitable chain extenders (CE) within the context of the present invention are also branched compounds such as 1,4-cyclohexanedimethanol, 2-butyl-2-ethylpropanediol, neopentyl glycol, 2,2,4-trimethylpentane-1,3-diol, pinacol, 2-ethylhexane-1,3-diol or cyclohexane-1,4-diol.

According to a further embodiment, the present invention is also directed to foamed pellets as disclosed above, wherein the chain extender is selected from the group consisting of ethylene glycol, 1,3-propane diol, 1,4-butane diol, and 1,6-hexane diol.

In the context of the present invention, the components used in the process for preparing the thermoplastic polyurethane can vary in wide ranges. It has been found that it is advantageous to react the components at an index in the range of from 950 to 1030, preferably in the range of from 980 to 1020, in particular in the range of from 990 to 1010.

According to a further embodiment, the present invention is also directed to foamed pellets as disclosed above, wherein the components are reacted at an index in the range of from 950 to 1030 in step (ii).

Suitable further reactants and reaction conditions are foe example disclosed in EP 0571 831, DE 1 962 5987 A1, EP 1 031 588 B1, EP 1 213 307 B1 and EP 1 338 614 B1.

According to the present invention, the foamed pellets comprise the thermoplastic polyurethane. The foamed pellets may also comprise further components such as additives or fillers. Suitable additives are in principle known to the person skilled in the art. Suitable are for example processing aids, stabilizers, compatibilizers or pigments.

According to the present invention, the foamed pellets may also comprise further polymers. According to the present invention, the foamed pellets may comprise one or more further polymers. It is for example possible to use blends comprising the thermoplastic and one or more further polymer. Suitable polymers are in particular thermoplastic polymers, such as thermoplastic resins selected from the group consisting of polystyrene, high impact polystyrene, polyethylene, polypropylene, and polyethylene terephthalate and thermoplastic elastomers in general. The foamed pellets according to the present invention may also comprise mixtures of the polymers in form of blends.

According to a further embodiment, the present invention is also directed to foamed pellets as disclosed above, wherein the foamed pellets further comprise a thermoplastic resin selected from the group consisting of polystyrene, high impact polystyrene, polyethylene, polypropylene, polyethylene terephthalate, and thermoplastic elastomers in general or mixtures thereof.

According to a further aspect, the present invention is also directed to a process for the production of foamed pellets comprising the steps (i) and (ii):
(i) reacting a polyol composition (PZ-1) comprising at least one hydroxy functionalized polyol (P1) with maximal 20% of primary hydroxyl groups with a polyisocyanate (I1) to obtain a polyol composition (PZ-2) containing a prepolymer (PP-1),
(ii) reacting polyol composition (PZ-2) containing the prepolymer (PP-1) with a composition (C2) comprising a chain extender (CE) with a molecular weight<500 g/mol.

In a further aspect, the present invention also relates to a process for the production of foamed pellets. In this case, the present invention relates to a process for the production of foamed pellets comprising the steps of
(A) providing a composition (C1) comprising a thermoplastic polyurethane, wherein the thermoplastic polyurethane is obtained or obtainable by a process comprising the steps (i) and (ii):
   (i) reacting a polyol composition (PZ-1) comprising at least one hydroxy functionalized polyol (P1) with maximal 20% of primary hydroxyl groups with a polyisocyanate (I1) to obtain a polyol composition (PZ-2) containing a prepolymer (PP-1),
   (ii) reacting polyol composition (PZ-2) containing the prepolymer (PP-1) with a composition (C2) comprising a chain extender (CE) with a molecular weight<500 g/mol;
(B) impregnating the composition (C1) with a blowing agent under pressure;
(C) expanding the composition (C1) by means of pressure decrease.

Within the context of the present invention, the composition (C1) can be used here in the form of a melt or in the form of pellets.

As regards preferred embodiments of the process, suitable feedstocks or mixing ratios, refer-ence is made to the statements above which apply correspondingly.

The inventive process may comprise further steps, for example temperature adjustments.

According to a further aspect, the present invention is also directed to foamed pellets obtained or obtainable by a process as disclosed above.

The unexpanded polymer mixture of the composition (C1) required for the production of the foamed pellets is produced in a known manner from the individual components and also optionally further components such as, by way of example, processing aids, stabilizers, compatibilizers or pigments. Examples of suitable processes are conventional mixing processes with the aid of a kneader, in continuous or batchwise mode, or with the aid of an extruder, for example a co-rotating twin-screw extruder.

In the case of compatibilizers or auxiliaries, such as for example stabilizers, these may also already be incorporated into the components during the production of the latter. The individual components are usually combined before the mixing process, or metered into the apparatus that performs the mixing. In the case of an extruder, the components are all metered into the intake and conveyed together into the extruder, or individual components are added in via a side feed.

The processing takes place at a temperature at which the components are present in a plas-tified state. The temperature depends on the softening or melting ranges of the components, but must be below the decomposition temperature of each component. Additives such as pigments or fillers or others of the abovementioned customary auxiliaries are not also melted, but rather incorporated in the solid state.

Further embodiments using well-established methods are also possible here, with the processes used in the production of the starting materials being able to be integrated directly into the production.

For instance, it would for example be possible in the case of the belt process, to introduce the styrene polymer, the impact modifier and also fillers or colorants directly at the end of the belt at which the material is fed into an extruder in order to obtain lenticular granules.

Some of the abovementioned customary auxiliaries can be added to the mixture in this step.

The inventive foamed pellets generally have a bulk density of from 50 g/I to 250 g/I, preferably 60 g/I to 180 g/I, particularly preferably 80 g/I to 150 g/I. The bulk density is measured analo-gously to DIN ISO 697 (January, 1984), where, in contrast to the standard, the determination of the above values involves using a vessel having a 10 I volume instead of a vessel having a 0.5 I volume, since, especially for foam beads having low density and high mass, measurement using only 0.5 I volume is too imprecise.

As stated above, the diameter of the foamed pellets is from 0.2 to 20 mm, preferably 0.5 to 15 mm and especially from 1 to 12 mm. For non-spherical, for example elongate or cylindrical foamed pellets, diameter means the longest dimension.

The foamed pellets can be produced by the well-established methods known in the prior art by means of
(α) providing an inventive composition (C);
(β) impregnating the composition with a blowing agent under pressure;
(γ) expanding the composition by means of pressure decrease.

The amount of blowing agent is preferably 0.1 to 80 parts by weight, especially 0.5 to 35 parts by weight and particularly preferably 1 to 30 parts by weight, based on 100 parts by weight of the amount used of composition (C).

One embodiment of the abovementioned process comprises
(α′) providing an inventive composition (C) in the form of pellets;
(β′) impregnating the pellets with a blowing agent under pressure;
(γ′) expanding the pellets by means of pressure decrease.

A further embodiment of the abovementioned process comprises a further step:
(α′) providing an inventive composition (C) in the form of pellets;
(β′) impregnating the pellets with a blowing agent under pressure;
(γ′-a) reducing the pressure to standard pressure without foaming the pellets, optionally by means of prior reduction of the temperature
(γ′-b) foaming the pellets by means of a temperature increase.

The unexpanded pellets preferably have an average minimal diameter of 0.2-10 mm here (determined via 3D evaluation of the pellets, for example via dynamic image analysis with the use of a PartAn 3D optical measuring apparatus from Microtrac).

The individual pellets generally have an average mass in the range from 0.1 to 50 mg, preferably in the range from 2 to 48 mg and particularly preferably in the range from 4 to 45 mg, more preferably in the range of from 4 to 40 mg This average mass of the pellets (particle weight) is determined as the arithmetic average by means of three weighing operations of in each case 10 pellet particles.

One embodiment of the abovementioned process comprises impregnating the pellets with a blowing agent under pressure and subsequently expanding the pellets in steps (I) and (I1):
(I) impregnating the pellets in the presence of a blowing agent under pressure at elevated temperatures in a suitable, closed reaction vessel (e.g. autoclaves)
(II) sudden depressurization without cooling.

The impregnation in step (I) can take place here in the presence of water and optionally suspension auxiliaries, or solely in the presence of the blowing agent and in the absence of water.

Suitable suspension auxiliaries are, for example, water-insoluble inorganic stabilizers, such as tricalcium phosphate, magnesium pyrophosphate, metal carbonates; and also polyvinyl alcohol and surfactants, such as sodium dodecylarylsulfonate. They are typically used in amounts of from 0.05 to 10% by weight, based on the inventive composition.

Depending on the chosen pressure, the impregnation temperatures are in the range from 100° C. to 200° C., where the pressure in the reaction vessel is in the range of from 0.2 to 15.0 MPa preferably between 0.5 and 10.0 MPa, particularly preferably between 2.0 and 6.0 MPa, the impregnation time generally being from 0.5 to 10 hours.

Carrying out the process in suspension is known to those skilled in the art and has been described, by way of example, extensively in WO2007/082838.

When carrying out the process in the absence of the water, care must be taken to avoid aggre-gation of the polymer pellets.

Suitable blowing agents for carrying out the process in a suitable closed reaction vessel are by way of example organic liquids and gases which are in a gaseous state under the processing conditions, such as hydrocarbons or inorganic gases or mixtures of organic liquids or gases with inorganic gases, where these may also be combined.

Examples of suitable hydrocarbons are halogenated or non-halogenated, saturated or unsaturated aliphatic hydrocarbons, preferably non-halogenated, saturated or unsaturated aliphatic hydrocarbons.

Preferred organic blowing agents are saturated, aliphatic hydrocarbons, in particular those having 3 to 8 carbon atoms, for example butane or pentane.

Suitable inorganic gases are nitrogen, air, ammonia or carbon dioxide, preferably nitrogen or carbon dioxide, or mixtures of the abovementioned gases.

In a further embodiment, the impregnation of the pellets with a blowing agent under pressure comprises processes and subsequent expansion of the pellets in steps (α) and (β):
(α*) impregnating the pellets in the presence of a blowing agent under pressure at elevated temperatures in an extruder
(β*) pelletizing the composition emerging from the extruder under conditions that prevent un-controlled foaming.

Suitable blowing agents in this process version are volatile organic compounds having a boiling point at standard pressure, 1013 mbar, of −25° C. to 150° C., especially−10° C. to 125° C. Of good suitability are hydrocarbons (preferably halogen-free), especially C4-10-alkanes, for example the isomers of butane, of pentane, of hexane, of heptane and of octane, particularly preferably isobutane. Further possible blowing agents are moreover sterically more demanding compounds such as alcohols, ketones, esters, ethers and organic carbonates. Furthermore, nitrogen or carbon dioxide or mixtures containing nitrogen and carbon dioxide may be used as blowing agents.

In this case, the composition is mixed with the blowing agent, which is supplied to the extruder, under pressure in step (ii) in an extruder while melting. The mixture comprising blowing agent is extruded and pelletized under pressure, preferably using counterpressure controlled to a mod-erate level (an example being underwater pelletization). The melt strand foams in the process, and pelletization gives the foamed pellets.

Carrying out the process via extrusion is known to those skilled in the art and has been described, by way of example, extensively in WO2007/082838, and also in WO 2013/153190 A1.

Extruders that can be used are any of the conventional screw-based machines, in particular single-screw and twin-screw extruders (e.g. ZSK type from Coperion GmbH or ZE type from KraussMaffei), co-kneaders, Kombiplast machines, MPC kneading mixers, FCM mixers, KEX kneading screw-extruders and shear-roll extruders, as have been described by way of example in Saechtling (ed.), Kunststoff-Taschenbuch [Plastics Handbook], 27th edition, Hanser-Verlag, Munich 1998, chapters 3.2.1 and 3.2.4. The extruder is usually operated at a temperature at which the composition (C1) is present as a melt, for example at 120° C. to 250° C., in particular 150 to 210° C., and at a pressure, after addition of the blowing agent, of 40 to 200 bar, preferably 60 to 150 bar, particularly preferably 80 to 120 bar, in order to ensure homogenization of the blowing agent with the melt.

The process here can be conducted in an extruder or in an arrangement composed of one or more extruders. Thus, by way of example, the components can be melted and blended, and a blowing agent injected, in a first extruder. In the second extruder, the impregnated melt is ho-mogenized and the temperature and/or the pressure is adjusted. If, by way of example, three extruders are combined with one another, the mixing of the components and the injection of the blowing agent can also be split between two different process sections. If, as is preferred, only one extruder is used, all of the process steps—melting, mixing, injection of the blowing agent, homogenization and adjustment of the temperature and/or of the pressure—are carried out in a single extruder.

As an alternative and in accordance with the methods described in WO 2014/150122 or WO 2014/150124 A1, the corresponding foamed pellets, which are optionally even already colored, can be produced directly from the pellets in that the corresponding pellets are saturated with a supercritical liquid, are removed from the supercritical liquid, followed by
(i′) immersing the article in a heated fluid or
(ii′) irradiating the article with energetic radiation (e.g. infrared or microwave irradiation).

Examples of suitable supercritical liquids are those described in WO2014150122 or, e.g. carbon dioxide, nitrogen dioxide, ethane, ethylene, oxygen or nitrogen, preferably carbon dioxide or nitrogen.

The supercritical liquid here can also comprise a polar liquid with Hildebrand solubility parame-ter equal to or greater than 9 M Pa^{-1/2}.

The supercritical fluid or the heated fluid may also comprise a colorant here, as a result of which a colored, foamed article is obtained.

The present invention further provides a molded body produced from the inventive foamed pellets. According to a further aspect, the present invention is also directed to the use of foamed pellets according to the invention for the production of a molded body.

The corresponding molded bodies can be produced by methods known to those skilled in the art. It is for example possible to use fusion techniques or to embed the foamed pellets in a coating layer or a foam to produce the molded bodies according to the present invention.

A process preferred here for the production of a foam molding comprises the following steps:
(A) introducing the foamed pellets according to the present invention into an appropriate mold;
(B) fusing the foamed pellets according to the present invention.

The fusing in step (B) is preferably affected in a closed mold, wherein the fusing can be affected by means of steam, hot air (as described for example in EP197940161) or energetic radiation (microwaves or radio waves). According to the present invention, fusing can be carried out in a continuous process or batch wise.

The temperature during the fusing of the foamed pellets is preferably below or close to the melting temperature of the polymer from which the bead foam was produced. For the widely used polymers, the temperature for the fusing of the foamed pellets is accordingly between 100° C. and 180° C., preferably between 120 and 150° C.

Temperature profiles/residence times can be ascertained individually here, for example in analogy to the processes described in US20150337102 or EP2872309B1.

The fusion by way of energetic radiation generally takes place in the frequency range of microwaves or radio waves, optionally in the presence of water or of other polar liquids, for example microwave-absorbing hydrocarbons having polar groups (such as for example esters of carboxylic acids and of diols or of triols, or glycols and liquid polyethylene glycols), and can be effected in analogy to the processes described in EP3053732A or WO16146537.

According to a further embodiment, the present invention is also directed to the use of the foamed pellets as disclosed above, wherein the molded body is produced by means of fusion or bonding of the beads to one another.

As stated above, the foamed pellets can also comprise colorants. Colorants can be added here in various ways.

In one embodiment, the foamed pellets produced can be colored after production. In this case, the corresponding foamed pellets are contacted with a carrier liquid comprising a colorant, where the carrier liquid (CL) has a polarity that is suitable for sorption of the carrier liquid into the foamed pellets to occur. This can be carried out in analogy to the methods described in the EP application having application Ser. No. 17/198,591.4.

Examples of suitable colorants are inorganic or organic pigments. Examples of suitable natural or synthetic inorganic pigments are carbon black, graphite, titanium oxides, iron oxides, zirconium oxides, cobalt oxide compounds, chromium oxide compounds, copper oxide compounds. Examples of suitable organic pigments are azo pigments and polycyclic pigments.

In a further embodiment, the color can be added during the production of the foamed pellets. By way of example, the colorant can be added into the extruder during the production of the foamed pellets via extrusion.

As an alternative, material that has already been colored can be used as starting material for the production of the foamed pellets, this being extruded—or being expanded in the closed vessel by the processes mentioned above.

In addition, in the process described in WO2014150122, the supercritical liquid or the heated liquid may comprise a colorant.

As stated above, the inventive moldings have advantageous properties for the abovementioned applications in the shoe and sports shoe sector requirement.

In this case, the tensile and compression properties of the molded bodies produced from the foamed pellets are adjusted to a suitable tensile strength, for example above 200 kPa (according to DIN EN ISO 1798, April 2008, a suitable n elongation at break, for example above 30% according to DIN EN ISO 1798, April 2008 and a suitable compressive stress, for example below 500 kPa at 50% compression (analogous to DIN EN ISO 844, November 2014, the devia-tion from the standard being that the height of the sample is 20 mm instead of 50 mm and therefore the test speed is adjusted to 2 mm/min) in a suitable range for a given application.

As stated above, there is a relationship between the density and compression properties of the molded bodies produced. The density of the moldings produced is advantageously from 75 to 375 kg/m³, preferably from 100 to 300 kg/m³, particularly preferably from 150 to 300 kg/m³ (DIN EN ISO 845, October 2009).

The ratio of the density of the molding to the bulk density of the inventive foamed pellets here is generally between 1.5 and 2.5, preferably 1.8 to 2.0.

The invention additionally provides for the use of inventive foamed pellets for the production of a molded body for shoe intermediate soles, shoe insoles, shoe combisoles, bicycle saddles, bicycle tires, damping elements, cushioning, mattresses, underlays, grips, protective films, in components in automobile interiors and exteriors, in balls and sports equipment or as floor covering, especially for sports surfaces, track and field surfaces, sports halls, shock pads, children's playgrounds and pathways.

According to a further embodiment, the present invention is also directed to the use of the foamed pellets as disclosed above, wherein the molded body is a shoe sole, part of a shoe sole, a bicycle saddle, cushioning, a mattress, underlay, grip, protective film, a component in automobile interiors and exteriors.

According to a further aspect, the present invention is also directed to the use of foamed pellets according to the present invention in balls and sports equipment or as floor covering and wall paneling, especially for sports surfaces, track and field surfaces, sports halls, children's playgrounds and pathways.

In a further aspect, the present invention also relates to a hybrid material comprising a matrix composed of a polymer (PM) and foamed pellets according to the present invention. Materials which comprise foamed pellets and a matrix material are referred to as hybrid materials within the context of the present invention. Here, the matrix material may be composed of a compact material or likewise of a foam.

Polymers (PM) suitable as matrix material are known per se to those skilled in the art. By way of example, ethylene-vinyl acetate copolymers, epoxide-based binders or else polyurethanes are suitable within the context of the present invention. In this case, polyurethane foams or else compact polyurethanes, such as for example thermoplastic polyurethanes, are suitable according to the invention.

According to the invention, the polymer (PM) is chosen here such that there is sufficient adhesion between the foamed pellets and the matrix to obtain a mechanically stable hybrid material.

The matrix may completely or partially surround the foamed pellets here. According to the invention, the hybrid material can comprise further components, by way of example further fillers or also pellets. According to the invention, the hybrid material can also comprise mixtures of different polymers (PM). The hybrid material can also comprise mixtures of foamed pellets.

Foamed pellets that can be used in addition to the foamed pellets according to the present invention are known per se to those skilled in the art. Foamed pellets composed of thermoplastic polyurethanes are particularly suitable within the context of the present invention.

In one embodiment, the present invention accordingly also relates to a hybrid material comprising a matrix composed of a polymer (PM), foamed pellets according to the present invention and further foamed pellets composed of a thermoplastic polyurethane.

Within the context of the present invention, the matrix consists of a polymer (PM). Examples of suitable matrix materials within the context of the present invention are elastomers or foams, especially foams based on polyurethanes, for example elastomers such as ethylene-vinyl acetate copolymers or else thermoplastic polyurethanes.

The present invention accordingly also relates to a hybrid material as described previously, wherein the polymer (PM) is an elastomer. The present invention additionally relates to a hybrid material as described previously, wherein the polymer (PM) is selected from the group consisting of ethylene-vinyl acetate copolymers and thermoplastic polyurethanes.

In one embodiment, the present invention also relates to a hybrid material comprising a matrix composed of an ethylene-vinyl acetate copolymer and foamed pellets according to the present invention.

In a further embodiment, the present invention relates to a hybrid material comprising a matrix composed of an ethylene-vinyl acetate copolymer, foamed pellets according to the present invention and further foamed pellets composed for example of a thermoplastic polyurethane.

In one embodiment, the present invention relates to a hybrid material comprising a matrix composed of a thermoplastic polyurethane and foamed pellets according to the present invention.

In a further embodiment, the present invention relates to a hybrid material comprising a matrix composed of a thermoplastic polyurethane, foamed pellets according to the present invention and further foamed pellets composed for example of a thermoplastic polyurethane.

Suitable thermoplastic polyurethanes are known per se to those skilled in the art. Suitable thermoplastic polyurethanes are described, for example, in “Kunststoffhandbuch [Plastics Handbook], volume 7, Polyurethane [Polyurethanes]”, Carl Hanser Verlag, 3rd edition 1993, chapter 3.

Within the context of the present invention, the polymer (PM) is preferably a polyurethane. “Polyurethane” within the meaning of the invention encompasses all known resilient polyisocyanate polyaddition products. These include, in particular, compact polyisocyanate polyaddition products, such as viscoelastic gels or thermoplastic polyurethanes, and resilient foams based on polyisocyanate polyaddition products, such as flexible foams, semirigid foams or integral foams. Within the meaning of the invention, “polyurethanes” are also understood to mean resilient polymer blends comprising polyurethanes and further polymers, and also foams of these polymer blends. The matrix is preferably a cured, compact polyurethane binder, a resilient polyurethane foam or a viscoelastic gel.

Within the context of the present invention, a “polyurethane binder” is understood here to mean a mixture which consists to an extent of at least 50% by weight, preferably to an extent of at least 80% by weight and especially to an extent of at least 95% by weight, of a prepolymer having isocyanate groups, referred to hereinafter as isocyanate prepolymer. The viscosity of the polyurethane binder according to the invention is preferably in a range here from 500 to 4000 mPa·s, particularly preferably from 1000 to 3000 mPa·s, measured at 25° C. according to DIN 53019-1:2008-09.

In the context of the invention, “polyurethane foams” are understood to mean foams according to DIN 7726 (1982-05).

The density of the matrix material is preferably in the range from 1.2 to 0.01 g/cm³. The matrix material particularly preferably is a resilient foam or an integral foam having a density in the range from 0.8 to 0.1 g/cm³, especially from 0.6 to 0.3 g/cm³, or a compact material, for example a cured polyurethane binder.

Foams are particularly suitable matrix materials. Hybrid materials comprising a matrix material composed of a polyurethane foam preferably exhibit good adhesion between the matrix material and foamed pellets.

In one embodiment, the present invention also relates to a hybrid material comprising a matrix composed of a polyurethane foam and foamed pellets according to the present invention.

In a further embodiment, the present invention relates to a hybrid material comprising a matrix composed of a polyurethane foam, foamed pellets according to the present invention and further foamed pellets composed for example of a thermoplastic polyurethane.

In one embodiment, the present invention relates to a hybrid material comprising a matrix composed of a polyurethane integral foam and foamed pellets according to the present invention.

In a further embodiment, the present invention relates to a hybrid material comprising a matrix composed of a polyurethane integral foam, foamed pellets according to the present invention and further foamed pellets composed for example of a thermoplastic polyurethane.

An inventive hybrid material, comprising a polymer (PM) as matrix and inventive foamed pellets, can by way of example be produced by mixing the components used to produce the polymer (PM) and the foamed pellets optionally with further components, and reacting them to give the hybrid material, where the reaction is preferably effected under conditions under which the foamed pellets are essentially stable.

Suitable processes and reaction conditions for producing the polymer (PM), in particular an eth-ylene-vinyl acetate copolymer or a polyurethane, are known per se to those skilled in the art.

In a preferred embodiment, the inventive hybrid materials are integral foams, especially integral foams based on polyurethanes. Suitable processes for producing integral foams are known per se to those skilled in the art. The integral foams are preferably produced by the one-shot process using the low-pressure or high-pressure technique in closed, advantageously temperature-controlled molds. The molds are preferably made of metal, for example aluminum or steel. These procedures are described for example by Piechota and Rohr in “Integralschaumstoff” [Integral Foam], Carl-Hanser-Verlag, Munich, Vienna, 1975, or in “Kunststoff-Handbuch” [Plastics Handbook], volume 7, “Polyurethane” [Polyurethanes], 3rd edition, 1993, chapter 7.

If the inventive hybrid material comprises an integral foam, the amount of the reaction mixture introduced into the mold is set such that the molded bodies obtained and composed of integral foams have a density of 0.08 to 0.70 g/cm³, especially of 0.12 to 0.60 g/cm³. The degrees of compaction for producing the molded bodies having a compacted surface zone and cellular core are in the range from 1.1 to 8.5, preferably from 2.1 to 7.0.

It is therefore possible to produce hybrid materials having a matrix composed of a polymer (PM) and the inventive foamed pellets contained therein, in which there is a homogeneous distribution of the foamed beads. The inventive foamed pellets can be easily used in a process for the production of a hybrid material since the individual beads are free-flowing on account of their low size and do not place any special requirements on the processing. Techniques for homogeneously distributing the foamed pellets, such as slow rotation of the mold, can be used here.

Further auxiliaries and/or additives may optionally also be added to the reaction mixture for producing the inventive hybrid materials. Mention may be made by way of example of surface-active substances, foam stabilizers, cell regulators, release agents, fillers, dyes, pigments, hy-drolysis stabilizers, odor-absorbing substances and fungistatic and bacteriostatic substances.

Examples of surface-active substances that can be used are compounds which serve to support homogenization of the starting materials and which optionally are also suitable for regulating the cell structure. Mention may be made by way of example of emulsifiers, for example the sodium salts of castor oil sulfates or of fatty acids and also salts of fatty acids with amines, for example diethylamine oleate, diethanolamine stearate, diethanolamine ricinoleate, salts of sulfonic acids, for example alkali metal or ammonium salts of dodecylbenzene- or dinaphthylmethanedisulfonic acid and ricinoleic acid; foam stabilizers, such as siloxane-oxyalkylene copolymers and other organopolysiloxanes, ethoxylated alkylphenols, ethoxylated fatty alcohols, paraffin oils, castor oil esters or ricinoleic esters, turkey red oil and peanut oil, and cell regulators, for example paraffins, fatty alcohols and dimethylpolysiloxanes. Oligomeric acrylates having polyoxyalkylene and fluoroalkane radicals as pendant groups are also suitable for improving the emulsifying action, cell structure and/or stabilization of the foam.

Suitable release agents for example include: reaction products of fatty acid esters with polyisocyanates, salts of amino group-comprising polysiloxanes and fatty acids, salts of saturated or unsaturated (cyclo)aliphatic carboxylic acids having at least 8 carbon atoms and tertiary amines, and also in particular internal release agents, such as carboxylic esters and/or carboxylic am-ides, produced by esterification or amidation of a mixture of montanic acid and at least one aliphatic carboxylic acid having at least 10 carbon atoms with at least difunctional alkanolamines, polyols and/or polyamines having molecular weights of 60 to 400, mixtures of organic amines, metal salts of stearic acid and organic mono- and/or dicarboxylic acids or anhydrides thereof or mixtures of an imino compound, the metal salt of a carboxylic acid and optionally a carboxylic acid.

Fillers, in particular reinforcing fillers, are understood to mean the customary organic and inorganic fillers, reinforcers, weighting agents, agents for improving abrasion behavior in paints, coating compositions etc., these being known per se. Specific examples which may be mentioned are: inorganic fillers such as siliceous minerals, for example sheet silicates such as antigorite, bentonite, serpentine, hornblendes, amphiboles, chrysotile, talc; metal oxides such as kaolin, aluminum oxides, titanium oxides, zinc oxide and iron oxides, metal salts such as chalk, barite and inorganic pigments such as cadmium sulfide, zinc sulfide and also glass and the like. Preference is given to using kaolin (china clay), aluminum silicate and coprecipitates of barium sulfate and aluminum silicate and also natural and synthetic fibrous minerals such as wollaston-ite, metal fibers and in particular glass fibers of various lengths, which may optionally have been sized. Examples of organic fillers that can be used are: carbon black, melamine, colophony, cyclopentadienyl resins and graft polymers, and also cellulose fibers, polyamide fibers, polyac-rylonitrile fibers, polyurethane fibers, polyester fibers based on aromatic and/or aliphatic dicarboxylic esters, and in particular carbon fibers.

The inorganic and organic fillers can be used individually or as mixtures.

The inventive hybrid materials, in particular hybrid materials having a matrix composed of cellular polyurethane, feature very good adhesion of the matrix material to the inventive foamed pellets. As a result, there is preferably no tearing of an inventive hybrid material at the interface between matrix material and foamed pellets. This makes it possible to produce hybrid materials which compared to conventional polymer materials, in particular conventional polyurethane materials, for a given density have improved mechanical properties, such as tear propagation re-sistance and elasticity.

The elasticity of inventive hybrid materials in the form of integral foams is preferably greater than 30% and particularly preferably greater than 50% according to DIN 53512 (2000-04).

The inventive hybrid materials, especially those based on integral foams, additionally exhibit high rebound resiliences at low density. Integral foams based on inventive hybrid materials are therefore outstandingly suitable in particular as materials for shoe soles. Light and comfortable soles with good durability properties are obtained as a result. Such materials are especially suitable as intermediate soles for sports shoes.

The inventive hybrid materials having a cellular matrix are suitable, for example, for cushioning, for example of furniture, and mattresses.

Hybrid materials having a matrix composed of a viscoelastic gel especially feature increased viscoelasticity and improved resilient properties. These materials are thus likewise suitable as cushioning materials, by way of example for seats, especially saddles such as bicycle saddles or motorcycle saddles.

Hybrid materials having a compact matrix are by way of example suitable as floor coverings, especially as covering for playgrounds, track and field surfaces, sports fields and sports halls.

The properties of the inventive hybrid materials can vary within wide ranges depending on the polymer (PM) used and in particular can be varied within wide limits by variation of size, shape and nature of the expanded pellets, or else by addition of further additives, for example also additional non-foamed pellets such as plastics pellets, for example rubber pellets.

The inventive hybrid materials have a high durability and toughness, which is made apparent in particular by a high tensile strength and elongation at break. In addition, inventive hybrid materials have a low density.

Further embodiments of the present invention can be found in the claims and the examples. It will be appreciated that the features of the subject matter/processes/uses according to the invention that are mentioned above and elucidated below are usable not only in the combination specified in each case but also in other combinations without departing from the scope of the invention. For example, the combination of a preferred feature with a particularly preferred feature or of a feature not characterized further with a particularly preferred feature etc. is thus also encompassed implicitly even if this combination is not mentioned explicitly.

The present invention is further illustrated by the following set of embodiments and combinations of embodiments resulting from the dependencies and back-references as indicated. In particular, it is noted that in each instance where a range of embodiments is mentioned, for example in the context of a term such as “The . . . of any one of embodiments 1 to 4”, every embodiment in this range is meant to be explicitly disclosed for the skilled person, i.e. the wording of this term is to be understood by the skilled person as being synonymous to “The . . . of any one of embodiments 1, 2, 3, and 4”. Further, it is explicitly noted that the following set of embodiments is not the set of claims determining the extent of protection, but represents a suitably structured part of the description directed to general and preferred aspects of the present invention.
1. Foamed pellets comprising a thermoplastic polyurethane obtainable or obtained by a process comprising steps (i) and (ii):
   (i) reacting a polyol composition (PZ-1) comprising at least one hydroxy functionalized polyol (P1) with maximal 20% of primary hydroxyl groups with a polyisocyanate (I1) to obtain a polyol composition (PZ-2) containing a prepolymer (PP-1),
   (ii) reacting polyol composition (PZ-2) containing the prepolymer (PP-1) with a composition (C2) comprising a chain extender (CE) with a molecular weight<500 g/mol.
2. The foamed pellets according to embodiment 1, wherein the polyol (P1) contains more than 94% non-primary hydroxyl groups.
3. The foamed pellets according to any of embodiments 1 or 2, wherein the number average molar mass (Mₙ) of the polyol (P1) is in the range of from 500 to 2500 g/mol.
4. The foamed pellets according to embodiment 1 to 3, wherein the polyol (P1) is polypropylene glycol.
5. The foamed pellets according to any of embodiments 1 to 4, wherein the chain extender is selected from the group consisting of ethylene glycol, 1,3-propane diol, 1,4-butane diol, and 1,6-hexane diol.
6. The foamed pellets according to any of embodiments 1 to 5, wherein the foamed pellets further comprise a thermoplastic resin selected from the group consisting of polystyrene, high impact polystyrene, polyethylene, polypropylene, and polyethylene terephthalate or mixtures thereof.
7. The use of foamed pellets according to any of embodiments 1 to 6 for the production of a molded body.
8. The use according to embodiment 7, wherein the molded body is produced by means of fusion or bonding of the beads to one another.
9. The use according to embodiment 7 or 8, wherein the molded body is a shoe sole, part of a shoe sole, shoe intermediate sole, shoe insole, shoe combisole, a bicycle saddle, a bicycle tire, a damping element, cushioning, a mattress, underlay, grip, protective film, a component in automobile interiors and exteriors.
10. The use of foamed pellets according to any of embodiments 1 to 6 in balls and sports equipment or as floor covering and wall paneling, especially for sports surfaces, track and field surfaces, sports halls, shock pads, children's playgrounds and pathways.
11. A hybrid material comprising a matrix composed of a polymer (PM) and foamed pellets according to any of embodiments 1 to 6.
12. A process for the production of foamed pellets comprising the steps (i) and (ii):
   (i) reacting a polyol composition (PZ-1) comprising at least one hydroxy functionalized polyol (P1) with maximal 20% of primary hydroxyl groups with a polyisocyanate (I1) to obtain a polyol composition (PZ-2) containing a prepolymer (PP-1),
   (ii) reacting polyol composition (PZ-2) containing the prepolymer (PP-1) with a composition (C2) comprising a chain extender (CE) with a molecular weight<500 g/mol.
13. The process according to embodiment 12, wherein the polyol (P1) contains more than 94% non-primary hydroxyl groups.
14. The process according to any of embodiments 12 or 13, wherein the number average molar mass (Mₙ) of the polyol (P1) is in the range of from 500 to 2500 g/mol.
15. The process according to embodiment 12 to 14, wherein the polyol (P1) is polypropylene glycol.
16. The process according to any of embodiments 12 to 15, wherein the chain extender is selected from the group consisting of ethylene glycol, 1,3-propane diol, 1,4-butane diol, and 1,6-hexane diol.
17. The process according to any of embodiments 12 to 16, wherein the foamed pellets further comprise a thermoplastic resin selected from the group consisting of polystyrene, high impact polystyrene, polyethylene, polypropylene, and polyethylene terephthalate or mixtures thereof.
19. A hybrid material comprising a matrix composed of a polymer (PM) and foamed pellets obtainable or obtained by a process according to embodiment 7.
20. Foamed pellets obtained or obtainable by a process according to embodiment 12.
21. Foamed pellets obtained or obtainable by a process according to any of embodiments 13 to 17.
22. Foamed pellets obtained or obtainable by a process for the production of foamed pellets comprising the steps (i) and (ii):
   (i) reacting a polyol composition (PZ-1) comprising at least one hydroxy functionalized polyol (P1) with maximal 20% of primary hydroxyl groups with a polyisocyanate (I1) to obtain a polyol composition (PZ-2) containing a prepolymer (PP-1),
   (ii) reacting polyol composition (PZ-2) containing the prepolymer (PP-1) with a composition (C2) comprising a chain extender (CE) with a molecular weight<500 g/mol.
23. The use of foamed pellets according to any of embodiments 20 to 22 for the production of a molded body.
24. The use according to embodiment 23, wherein the molded body is produced by means of fusion or bonding of the beads to one another.
25. The use according to embodiment 23 or 24, wherein the molded body is a shoe sole, part of a shoe sole, shoe intermediate sole, shoe insole, shoe combisole, a bicycle saddle, a bicycle tire, a damping element, cushioning, a mattress, underlay, grip, protective film, a component in automobile interiors and exteriors.
26. The use of foamed pellets according to any of embodiments 20 to 23 in balls and sports equipment or as floor covering and wall paneling, especially for sports surfaces, track and field surfaces, sports halls, shock pads, children's playgrounds and pathways.
27. A hybrid material comprising a matrix composed of a polymer (PM) and foamed pellets according to any of embodiments 20 to 22.

The following examples serve to illustrate the invention, but are in no way restrictive in respect of the subject matter of the present invention.

### EXAMPLES

1. Evaluations and Measurement Methods

| | |
|---|---|
| Melt Flow Rate (MFR) | DIN EN ISO 1133: 2012-03 |
| Tensile strength | DIN 53504: 2009-10 |
| Elongation at break | DIN 53504: 2009-10 |
| Bulk Density (BD) | DIN ISO 697: 1984-01 |
| S2- Bodies | DIN 53504: 2009-10 |

2. Materials used
   Polyol 1 (PPG-1000): Polypropylene glycol with a hydroxyl number of 104 mg/KOH/g having predominantly secondary hydroxyl groups.
   Polyol 2 (PPG-EO): Poly(propylene-b-ethylene) glycol with a hydroxyl number of 63 mg KOH/g having a mixture of secondary and primary hydroxyl groups.
   Isocyanate: 4,4′-Methylene diphenyl diisocyanate
   Chain extender: 1,4-Butane diol
   Catalyst: Tin-II-isooctoate (50% in dioctyladipate)
   Surfactant 1: Calciumcarbonat (CaCO₃)
   Surfactant 2: Ethoxylated (25 EO) C16C18-Fatty alcohol
3. Examples—Preparation of prepolymers
3.1 Pre-polymer (TPU-1)

A prepolymer was prepared using 4,4′-methylene diphenyl diisocyanate, tin-II-isooctoate as a catalyst and a polyetherol as indicated in table 1 in an adiabatic continuous reactor with a residence time of about 10 minutes. The components were premixed before addition to the reactor and heated to a temperature of 100° C. to 120° C. After the adiabatic continuous reactor unit, the prepolymer is cooled down to a temperature of 60° C. to 90° C. By addition of the chain extender 1,4-butanediol which was heated to 60° C. prior to the addition and further temperature adjustment to a temperature of 110 to 180° C. of the reaction mixture on a beltline with a residence tome of 5 to 10 minutes, the thermoplastic polyurethane was obtained.

The thermoplastic polyurethane obtained was granulated and 2 mm bodies were prepared by injection molding. The S2-bodies (according to DIN 53504:2009-10) were tested. The mechanical properties are summarized in table 2.

The maximum temperature of the melt was 240° C.
3.2 One-shot (TPU-2, TPU-3. TPU-4)

A thermoplastic polyurethane was prepared using 4,4′-methylene diphenyl diisocyanate, the chain extender 1,4-butanediol, tin-II-isooctoate as a catalyst and a polyetherol as indicated in table 1 in a reactor. After a reaction temperature of 110° C. was reached, the reaction mixture was added on a beltline with a residence time of 5 to 10 minutes, the thermoplastic polyurethane was obtained.

The thermoplastic polyurethane obtained was tempered for 15 h at 80° C. and was subsequently granulated. 2 mm bodies were prepared by injection molding from the granules. The S2-bodies obtained (according to DIN 53504, 2009-10) were tested. The mechanical properties are summarized in table 2.

The maximum temperature of the melt in the preparation process was 240° C.

TABLE 1
Composition of tested TPUs

| | TPU No. | | | | | | | |
|---|---|---|---|---|---|---|---|---|
| | TPU-1 | | TPU-2 | | TPU-3 | | TPU-4 | |
| | Pre-Polymer | | One-shot | | one-shot | | One-shot | |
| Polyol 1 | 1000 | g | 1000 | g | 1000 | g | — | |
| Polyol 2 | — | | — | | — | | 1000 | g |
| Isocyanate | 621.11 | g | 515.52 | g | 515.52 | g | 630 | g |
| Chain Extender | 139.79 | g | 130.76 | g | 130.76 | g | 174.67 | g |
| Catalyst | 44 | μL | 41 | μL | 412 | μL | 44 | μL |

| | | | | |
|---|---|---|---|---|
| Index | 1000 | 1025 | 1025 | 1040 |

The mechanical properties of the materials obtained are summarized in table 2. For TPU-2 and TPU-3, no formed bodies could be obtained from the materials. It was not possible to determine the mechanical properties of the materials.

TABLE 2
Mechanical properties of TPUs

| | Trial No. | | | | | |
|---|---|---|---|---|---|---|
| | TPU-1 | | TPU-2 | TPU-3 | TPU-4 | |
| | Pre-Polymer | | One-shot | One-shot | One-shot | |
| PPG | PPG | | PPG | PPG | PPG-EO | |
| | Mn1000 | | Mn 1000 | Mn 1000 | Mn1000 | |
| | g/mol | | g/mol | g/mol | g/mol | |
| Index | 1000 | | 1000 | 1000 | 1040 | |
| Shore A | 80 | A | n.d. | n.d. | 89 | A |
| Tensile strength | 17 | MPa | n.d. | n.d. | 43 | MPa |
| Elongation @ | 690% | | n.d. | n.d. | 660% | |
| break | | | | | | |
| Mw Lsg 10 | 80 | kDa | n.d. | 32 kDa | 72 | kDa |

4. Expanded Beads
4.1 Extrusion Process—eTPU-1, eTPU-2, eTPU-4

For TPU-1 and TPU-4, the expanding process was conducted in a twin-screw extruder of company Coperion (ZSK 40). The material was dried for minimum 5 h at 70° C. directly before extrusion. During processing 0.1% of nucleating agent (particle size 5.6 μm—D50, distribution of volume) and if necessary different amounts of a TPU which was com-pounded in a separate extrusion process with 4,4-Diphenylmethandiisocyanat and poly-meric Diphenylmethandiisocyanat with a functionality of 2,05 (additive 1) or 2,4 (additive 2) was added. The temperature range of the extruder was 190° C. As blowing agent CO₂ and N₂ was injected into the melt and all added materials were mixed homogeneously with the thermoplastic polyurethane. Table 3 shows the different compositions of eTPU-1, eTPU-2 and eTPU-4.

After mixing of all components in the extruder the material was first pressed through a gear pump with a temperature of 170° C. and then through a die plate heated up to 140° C. The granulate was cut and formed in the underwater pelletizing system (UWP). During the transport out of the UWP the particles expands under defined conditions of temperature and pressure of the water. Before drying the material for 5 h at 50° C. a centrifugal drier was used for separating the granulate and the water.

Process details of all examples such as the used water temperatures and-pressure, amount of blowing agents CO₂ and N₂ as well as the particle mass and resulting bulk density are listed in table 3.

TABLE 3
Process details of eTPU extrusion-processing step

| | eTPU | | |
|---|---|---|---|
| | | | eTPU-4 |
| | eTPU-1 | eTPU-2 | (Reference) |
| TPU | TPU-1 | TPU-1 | TPU-4 |
| Content of TPU (% b.w.) | 99.4 | 99.4 | 99.9 |
| Content of nucleating agent (wt %) | 0.1 | 0.1 | 0.1 |
| Content of additive 1 (wt %) | 0.5 | — | — |
| Content of additive 2 (wt %) | — | 0.5 | — |
| Part.-Mas. (mg) | 22 | 22 | 22 |
| Bulk Density (g/L) | 147 | 127 g/L | 180 |
| CO₂ (wt %) | 1.2 | 1.2 | 1.7 |
| N₂ (wt %) | 0.21 | 0.21 | 0 |
| Pressure in UWP (bar) | 10.0 | 8.4 | 9.3 |
| Temperature in UWP(° C.) | 34 | 33 | 49 |

4.2 Autoclave Process—eTPU-3

For the examples, the inventive TPU-1 was used. Experiments are conducted in a closed pressure vessel (Impregnation vessel) at a filling level of 80% by volume.

100 parts by weight of particles from TPU-1 and a defined volume of water as suspension medium which results in a phase relationship P1 are mixed by stirring to get a homoge-nous suspension. Phase relationship P1 is defined as volume of solid particles divided by volume of water. 6.7% by weight, based on the solid particles, of a dispersing agent (surfactant 1), together with 0.13% by weight of an assistant system (surfactant 2), based on the solid particles, and a certain amount of butane as blowing agent, based on the solid particles, are added to the suspension and heated up during further stirring.

At 50° C., nitrogen as co-blowing agent was added by pressure increase, to a predetermined pressure within the vessel. The liquid phase of the suspension was heated to the predetermined impregnation temperature (IMT). The time (soaking time) between 5° C. below IMT until IMT is controlled to be within 3 min and 60 min. This correlates with a heating rate of 1.67° C./min until 0.083° C./min.

In this procedure, at IMT a defined pressure in gaseous phase (IMP) is formed.

After soaking time and at the reached IMT, the pressure was released and the whole content of the vessel (suspension) was poured through a relaxation device into a vessel under atmospheric pressure (expansion vessel). Expanded beads are formed.

During the relaxation step, the pressure within the impregnation vessel was fixed with nitrogen to a certain level (squeezing pressure SP).

Additionally, directly after the relaxation device, the expanding particles can by cooled by a certain flow of water with a certain temperature (water quench).

After removal of the dispersing agent and/or the assistant system (surfactant) and subsequent drying, the bulk density of the resulting foamed beads is measured (according to DIN ISO 697: 1984-01).

Details concerning manufacturing parameters are listed in table 4.

TABLE 4
Data for the manufacturing expanded beads

| eTPU | eTPU-3 |
|---|---|
| TPU | TPU-1 |
| Dispersing agent | Surfactant 1 |
| Assistant system | Surfactant 2 |
| Phase relationship P1 | 0.14 |
| Butane (wt %) | 24 |
| p after adding N₂ at 50° C. (bar) | 8 |
| Soaking time (min) | 4 |
| IMT (° C.) | 116 |
| SP (MPa) | 4.0 |
| Water quench | No |
| Bulk density (kg/m³) | 115 |

5. Steam Chest Molding & Mechanics

In a next step the expanded material was molded to quadratic test plates with a length of 200 mm×200 mm and thickness of 10 mm and 20 mm respectively using steam chest molding machine of company Kurtz ersa GmbH (Boost Foamer K68). The molding pa-rameter were identical, independent of thickness of test plates. Additionally, the crack steam was carried out by the movable side of the tool. The molding parameters are listed in table 5.

TABLE 5
Processing conditions for steam chest molding of examples

| | Example | | | |
|---|---|---|---|---|
| | | | | eTPU-4 |
| | eTPU-1 | eTPU-2 | eTPU-3 | (Reference) |
| Crack size (mm) | 14/22 | 14/22 | 14/22 | 14/22 |
| Crack steam fixed | — | — | — | — |
| side (bar) | | | | |
| Crack steam fixed | — | — | — | — |
| side (s) | | | | |
| Crack steam movable | 0.75 | 0.75 | 0.75 | 0.75 |
| side (bar) | | | | |
| Crack steam movable | 18 | 18 | 18 | 18 |
| side (s) | | | | |
| Cross steam fixed | 1.3/1.1 | 1.3/1.1 | 1.3/1.1 | 1.3/1.1 |
| side/counter | | | | |
| pressure (bar) | | | | |
| Cross steam fixed | 40/20 | 40/20 | 40/20 | 40/20 |
| side/counter | | | | |
| pressure (s) | | | | |
| Cross steam movable | — | — | — | — |
| side/counter | | | | |
| pressure (bar) | | | | |
| Cross steam | — | — | — | — |
| movable side/counter | | | | |
| pressure (s) | | | | |
| Autoclave steam | 1.3/0.8 | 1.3/0.8 | 1.3/0.8 | 1.3/0.8 |
| fixed/movable | | | | |
| side (bar) | | | | |
| Autoclave steam (s) | 10 | 10 | 10 | 10 |

The results of mechanical testing are listed in Table 6. Part density, tensile strength, elongation at break, and compression hardness are measured according to the following test methods:

Tensile strength and elongation at break are measured with a universal testing machine, which is equipped with a 2.5 kN force sensor (class 0,5 (ab 10N), DIN EN ISO 7500-1, 2018), a long-stroke-extensometer (class 1 after DIN EN ISO 9513, 2013) and pneumatic clamps (6 bar, clamping jaws out of pyramid grid (Zwick T600R)).

The specimens (150 mm×25.4 mm×thickness of the test plate) are culled from a 200×200×10 mm test plate (dimensions could vary slightly due to shrinkage) with a cutting die. Before, the test plates were stored for at least 16 h under standardized climate conditions (23±2° C. and 50±5% humidity). The measurement is also carried out in standard climate. For each specimen density is determined. Therefore, mass (precision scale; accuracy: ±0,001 g) and thickness (caliper; accuracy: ±0.01 mm, contact pressure 100 Pa, value is only measured once in the middle of the specimen) are measured. Length (150 mm) and width (25.4 mm) are known from the dimension of the cutting die.

The L_{E}-position (75 mm) and the distance of the long-stroke-extensometer d (50 mm) are checked before stating the measurement. The specimen is placed on the upper clamp and the force is tared. Then the specimen is clamped and measurement could be started. The measurement is carried out with a testing speed of 100 mm/min and a force of 1 N. The calculation of tensile strength σₘₐₓ (specified in M Pa) is done by equation (1), which is the maximum tension. This tension can be identical to the tension at breakage. Elongation at break ε (specified in %) is calculated using equation (2). Three specimens are tested for each material. The mean value from the three measurements is given. If the test specimen tears outside the selected area, this is noted. A repetition with another test specimen is not performed.

$${σ}_{max} = \frac{{F}_{max}}{d \cdot h} \qquad ( 1 )$$

σₘₐₓ=Tensile strength
Fₘₐₓ=Maximum tention [N]
D=Thickness of the specimen [mm]
B=Width of the specimen [mm]

$$ε = \frac{{L}_{B} - {L}_{0}}{{L}_{0}} \cdot 100 \% \qquad ( 2 )$$

ε=Eolongation at break
L_{B}=Length at breakage [mm]
L₀=Length before starting measurement [mm]

TABLE 6
Mechanical properties of molded examples

| | | Tensile | | Tensile |
|---|---|---|---|---|
| | Part Density | Strength | Compression | elongation |
| | (10 & 20 mm) | (10 mm) | hardness 50% | (10 mm) |
| | (g/cm³) | (MPa) | (20 mm)/(kPa) | (%) |
| eTPU-1 | 0.307/0.265 | 0.33 | 229 | 72 |
| eTPU-2 | 0.272/0.236 | 0.56 | 195 | 80 |
| eTPU-3 | 0.302/0.264 | 0.28 | 227 | 63 |
| eTPU-4 | 0.380/0.367 | 0.10 | 666 | 10 |
| (Reference) | | | | |

### LITERATURE CITED

WO 94/20568 Al
WO 2007/082838 A1
WO 2017/030835 A1
WO 201 3/1 531 90 Al
WO 201 0/01 001 0 Al
WO 02/064656 A2
WO 93/24549 Al
US 2006/0258831 A1
EP 1746117 A1
“Plastics Handbook, Volume 7, Polyurethanes”, Carl Hanser Verlag, 3rd Edition 1993, Chapter 3.1 and chapter 7
EP 0571 831 Al
DE 1 962 5987 Al
EP 1 031 588 B1
EP 1 213 307 B1
EP 1 338 614 B1
Kunststoff-Taschenbuch [Plastics Handbook], 27th edition, Hanser-Verlag, Munich 1998, chapters 3.2.1 and 3.2.4
WO 2014/150122 A1
WO 2014/150124 A1
EP 1979401 B1
US 2015/0337102
EP 2872309 B1
EP 3053732 A1
WO 2016/146537 A1
“Integralschaumstoff” [Integral Foam], Carl-Hanser-Verlag, Munich, Vienna, 1975

1-13. (canceled)

14. Foamed pellets, comprising a thermoplastic polyurethane obtained by a process comprising:
reacting a polyol composition (PZ-1) comprising at least one hydroxy functionalized polyol (P1) with a maximum of 20% of primary hydroxyl groups with a polyisocyanate (I1), to obtain a polyol composition (PZ-2) containing a prepolymer (PP-1),
(ii) reacting the polyol composition (PZ-2) containing the prepolymer (PP-1) with a composition (C2) comprising a chain extender (CE) with a molecular weight<500 g/mol,
wherein a diameter of the foamed pellets is from 0.2 to 20 mm.

15. The foamed pellets according to claim 14, wherein the at least one hydroxy functionalized polyol (P1) contains more than 94% of non-primary hydroxyl groups.

16. The foamed pellets according to claim 14, wherein a number average molar mass Mn) of the at least one hydroxy functionalized polyol (P1) is in a range of from 500 to 2500 g/mol.

17. The foamed pellets according to claim 14, wherein the at least one hydroxy functionalized polyol (P1) is polypropylene glycol.

18. The foamed pellets according to claim 14, wherein the chain extender (CE) is selected from the group consisting of ethylene glycol, 1,3-propane diol, 1,4-butane diol, and 1,6-hexane diol.

19. The foamed pellets according to claim 14, wherein the foamed pellets further comprise at least one thermoplastic resin selected from the group consisting of polystyrene, high impact polystyrene, polyethylene, polypropylene, polyethylene terephthalate, a thermoplastic elastomer, and a mixture thereof.

20. A process for the production of foamed pellets, comprising:
(i) reacting a polyol composition (PZ-1) comprising at least one hydroxy functionalized polyol (P1) with a maximum of 20% of primary hydroxyl groups with a polyisocyanate (I1), to obtain a polyol composition (PZ-2) containing a prepolymer (PP-1),
(ii) reacting the polyol composition (PZ-2) containing the prepolymer (PP-1) with a composition (C2) comprising a chain extender (CE) with a molecular weight<500 g/mol,
wherein a diameter of the foamed pellets is from 0.2 to 20 mm.

21. A method, comprising:
producing a molded body with the foamed pellets according to claim 14.

22. The method according to claim 21, wherein the molded body is produced by fusion or bonding of the foamed pellets to one another.

23. The method according to claim 21, wherein the molded body is a shoe sole, part of a shoe sole, shoe intermediate sole, shoe insole, shoe combisole, a bicycle saddle, a bicycle tire, a damping element, cushioning, a mattress, an underlay, a grip, a protective film, or a component in automobile interiors and exteriors.

24. An article, comprising the foamed pellets according to claim 14, wherein the article is selected from the group consisting of a ball, sports equipment, floor covering, and wall paneling.

25. A hybrid material, comprising a matrix composed of a polymer (PM) and the foamed pellets according to claim 14.

26. The article according to claim 24, wherein the article is selected from the group consisting of a sports surface, a track and field surface, a sports hall, a shock pad, a children's playground, and a pathway.
